(19) United States
(12) Patent Application Publication
(10) Pub. No.: US 2010/0284066 A1
(43) Pub. Date: Nov. 11, 2010

(54) MICROSCOPE

(75) Inventors: Keith James DUNNING, Bedford (GB); Richard John Dickinson, Cambridge (GB)

Correspondence Address: HESLIN ROTHENBERG FARLEY & MESITI PC, 5 COLUMBIA CIRCLE, ALBANY, NY, 12203, US

(73) Assignee: CAMBRIDGE OPTRONICS LIMITED, Bedford (GB)

(21) Appl. No.: 12/774,497

(22) Filed: May 5, 2010

(30) Foreign Application Priority Data
May 7, 2009 (GB) 09 07 802.3

(51) Int. Cl. G02B 21/04; G02B 21/06

(52) U.S. Cl. 359/381; 359/368; 359/390

(57) ABSTRACT

A compact, portable microscope for use in the field is provided with: an optical path extending within the microscope casing between a viewing port and an eyepiece element, which path is folded by a plurality of reflectors; and a cam and follower microscope focusing mechanism. The cam and follower microscope focusing mechanism is configured such that an objective lens element is moveable relative to a substantially planar viewing stage comprising the viewing port. A first portion of the folded optical path between the viewing port and a first reflector extends in a first plane substantially perpendicularly to a second plane in which the remainder of the optical path extends.

### CROSS REFERENCE TO RELATED APPLICATIONS

This application claims priority of United Kingdom application GB 09 07 802.3, filed on May 7, 2009, which application is hereby incorporated herein in its entirety.

1. Field of the Invention

The present invention relates to a microscope, in particular to a compact, portable optical microscope for field use.

2. Background to the Invention

Health workers in less-developed countries and in disaster areas frequently have difficulty in diagnosing diseases and infestations because they do not have easy access to conventional laboratory facilities. A high-magnification optical microscope for studying samples taken from patients or environmental samples can be very important in the diagnosis of conditions such as malaria, tuberculosis and helminthic infestations. However, conventional “bench” microscopes, particularly those capable of magnifications in the ×100 to ×1000 range, are bulky, heavy and can be fragile. They are also liable to malfunction in tropical conditions, especially in humid tropical conditions conducive to fungal growth. The high-intensity illumination arrangements used in such microscopes also require a mains electrical supply, or at least a connection to a 12V vehicle battery, which is either not available or, if available, not conveniently usable in some geographical area.

Attempts have been made to provide compact, portable, high-performance optical microscopes for use in the field, such as those described in European Patent Application No. 0361889 and International Patent Application No. W02004/049031, which utilise battery-powered illumination arrangements. However, the microscopes disclosed therein represent a compromise between reflected light illumination (for opaque samples) and transmission illumination (for transparent and translucent samples). They are also designed for a maximum magnification of ×160 in the former case and ×40 in the latter case, and it has been found that these designs cannot simply be extrapolated to provide the higher magnifications needed for medical and microbiological work.

It is known for conventional rack and pinion mechanisms to be used for focusing optical microscopes. However, there are several disadvantages associated with this type of mechanism. The rack and pinion mechanism has been found to frustrate the user, who wishes to find a focus point simply, quickly and with accuracy. With a rack and pinion mechanism, the user will not know which direction to turn the focus knob in order to head towards a focus point, and may then end up hunting to and fro, passing through the starting point. The focussing process tends to be made more difficult as a result of the rack and pinion mechanism suffering from stiction, which in turn produces a jerky motion. Thus, it is tedious for the user to find the position of best focus using a rack and pinion mechanism. In addition, traditional rack and pinion focusing mechanisms often undesirably allow the objective lens to come into contact with a sample. In some cases, travel limiting end stops are used in an attempt to overcome this problem but these can result in mechanical impact damage to the rack and pinion mechanism and hence the focal control of the microscope. Further, conventional rack and pinion mechanisms tend to be too costly and too large to be suitable for a compact, portable microscope for use in the field.

It is hence an object of the present invention to provide a portable optical microscope suitable for field use that obviates the above shortcomings of existing microscopes.

### SUMMARY OF THE INVENTION

According to a first aspect there is provided a microscope comprising: a casing comprising a substantially planar viewing stage having a viewing port extending therethrough, an eyepiece element, an objective lens element, an optical path extending within said casing between said viewing port and said eyepiece element and folded by means of a plurality of reflectors, and a focussing mechanism comprising a cam and follower mechanism and configured such that said objective lens element and said substantially planar viewing stage are relatively moveable by operation of said cam and follower mechanism.

In an embodiment, a first portion of the optical path between the viewing port and a first reflector of the plurality of reflectors extends in a first plane substantially perpendicularly to a second plane in which the remainder of the optical path extends. In an example, the first reflector is manufactured to an accuracy that is higher than the accuracy of each remaining reflector of the plurality of reflectors. In an example, the second plane extends substantially parallely to the substantially planar viewing stage.

In an embodiment, the focussing mechanism is configured such that the objective lens element is moveable relative to the substantially planar viewing stage by operation of the cam and follower mechanism. In an embodiment, the focussing mechanism is configured such that the objective lens element is moveable relative to the substantially planar viewing stage by operation of the cam and follower mechanism. In an example, the microscope comprises a biasing arrangement configured to maintain the mounting frame follower element in contact with the rotatable cam element.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 shows a microscope;

FIG. 2 shows features of the optical path of the microscope of FIG. 1;

FIG. 3 illustrates the cam and follower microscope focusing mechanism of the microscope of FIG. 1;

FIG. 4 shows the objective lens element of the microscope of FIG. 1; and

FIG. 5 & FIG. 6 each show further features of the microscope of FIG. 1.

### DETAILED DESCRIPTION

There will now be described by way of example a specific mode contemplated by the inventors. In the following description numerous specific details are set forth in order to provide a thorough understanding. It will be apparent however, to one skilled in the art, that the present invention may be practiced without limitation to these specific details. In other instances, well known methods and structures have not been described in detail so as not to unnecessarily obscure the description.

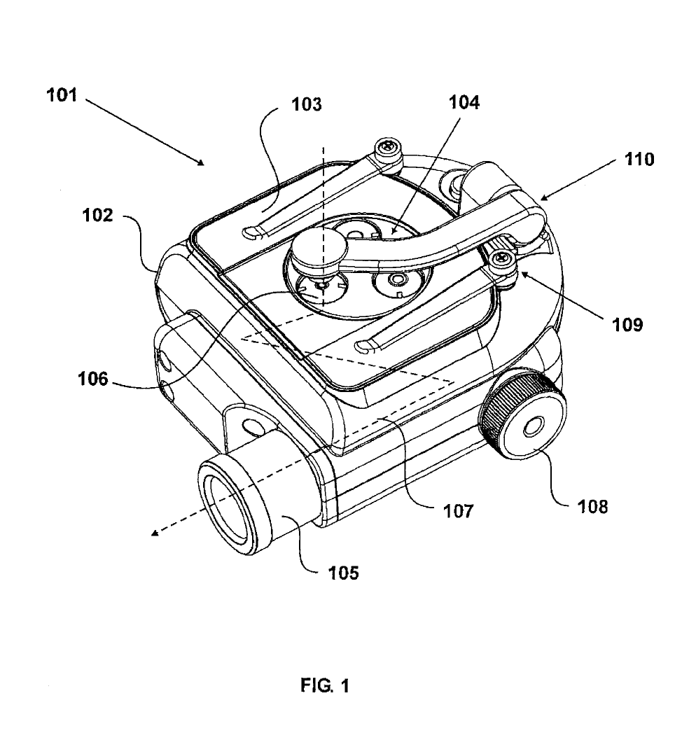

### FIG. 1

A microscope 101 is shown in FIG. 1. The microscope comprises a casing 102 comprising a substantially planar viewing stage 103 having a viewing port 104 extending therethrough. The microscope also comprises an eyepiece element 105 having an eyepiece lens and an objective lens element having at least one objective lens 106. An optical path 107 extends within the casing 102 between the viewing port 104 and the eyepiece element 105. This internal optical path is folded by a plurality of reflectors and this is described in further detail below. The microscope further comprises a focusing mechanism, which is manually operable by means of operation of focusing knob 108 and configured such that the objective lens 106 in the optical path 107 and the substantially planar viewing stage 103 are relatively moveable. The focusing mechanism comprises a cam and follower mechanism and this is described in detail below. Microscope 101 preferably comprises a retaining arrangement, indicated at 109, for use in retaining a sample upon the substantially planar viewing stage 103, within the viewing port 104. The microscope 101 also preferably comprises an illumination arrangement, indicated generally at 110, for illuminating a subject sample. Further features of the portable, optical microscope are described below.

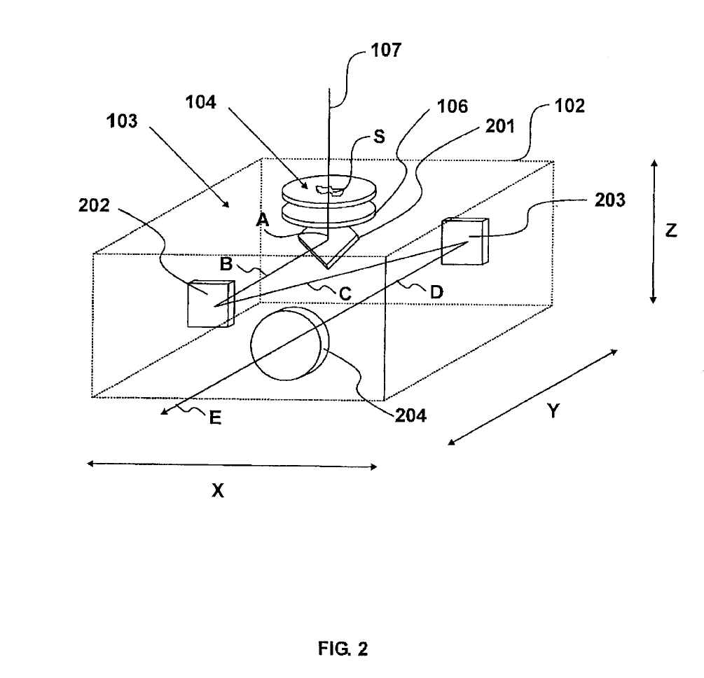

### FIG. 2

A schematic showing features of the optical path features of the microscope of FIG. 1 is shown in FIG. 2. Objective lens 106 is located within the casing 102, within the bounds of the viewing port 104, such that its optical axis extends substantially perpendicularly to the substantially planar viewing stage 103. In this example, the viewing port 104 is substantially circular; alternatively, the viewing port may be a different shape. The viewing port may be provided by an aperture defined in a face of casing 102. In an example, the viewing port is located substantially centrally of the substantially planar viewing stage 103.

Optical path 107 extends through the substantially planar viewing stage 103 and through the viewing port 104, so as to pass through a subject sample, indicated at S. The optical path 107 further extends through the objective lens 106 that is aligned with the viewing port 104. Optical path 107 then meets a first reflector 201, which turns the optical path through a right angle, such that the optical path extends substantially parallely to the substantially planar viewing stage 103. The first reflector 201 directs the optical path 107 towards second reflector 202. The second reflector 202 turns the optical path 107 towards third reflector 203, with the optical path remaining substantially parallel to the substantially planar viewing stage 103. The third reflector 203 turns the optical path 107 towards eyepiece element 105, again with the optical path remaining substantially parallel to the substantially planar viewing stage 103. In this Fig., the optical path is shown projecting from the casing 102, exiting through eyepiece element 105.

As shown, a first portion A of the optical path 107 extends between the viewing port 104 and the first reflector 201; a second portion B of the optical path 107 extends between the first reflector 201 and the second reflector 202; a third portion C of the optical path 107 extends between the second reflector 202 and the third reflector 203, and a fourth portion D of the optical path 107 extends between the third reflector 203 and the lens 204 of the eyepiece element. Light following the optical path thus passes from the lens 204 of the eyepiece element 105 to the viewer. In this example, the reflectors and the eyepiece lens all lie substantially in the same plane.

In this embodiment, first portion A of the optical path 107 between the viewing port 104 and the first reflector 201 of the plurality of reflectors extends in a first plane that is substantially perpendicular to a second plane in which the remaining portions B, C, D and E of the optical path 107 extends. As shown, the first portion A extends substantially perpendicularly to the substantially planar viewing stage 103 and the remaining portions B, C, D and E of the optical path extends substantially parallely to the substantially planar viewing stage 103. The folding of the optical path allows the microscope to be compact so as to be conveniently portable. By reflecting the incoming light, entering through the substantially planar viewing stage along a path extending perpendicularly thereto, into a path that traverses a plane extending parallely thereto, it is possible to provide a folded optical path of considerable effective length within a relatively compact casing 102.

According to this illustrated example, the plurality of reflectors comprises 3 mirrors. However, alternative reflector arrangements may comprise a lesser or greater number of reflectors and may comprise any suitable type of reflector or combination of types of reflector. In an example, the first reflector that is angled at 45° to the first portion A, so as to turn the optical path through 90° , is manufactured to an accuracy of at least 2 fringes. The remaining reflectors may then be manufactured to a lower accuracy, for example to an accuracy of 4 to 5 fringes.

In an embodiment, the net length of the optical path from the objective lens to the eyepiece lens is equivalent to a standard conventional microscope tube length. In an example, a microscope is provided that has an optical path in accordance with the Royal Microscopical Society (RMS) standard 160 mm tube length and an overall size of approximately 125 mm (X-direction) by 150 mm (Y-direction) by 70 mm (Z-direction). A microscope as described herein providing an RMS 160 mm standard tube length conveniently allows the use of standard lenses and accessories that are compatible with an RMS 160 mm standard tube length microscope to be used therewith. Use of existing equipment in the microscope serves to increase the usability of the microscope, through the convenient, economical and practical use of available components.

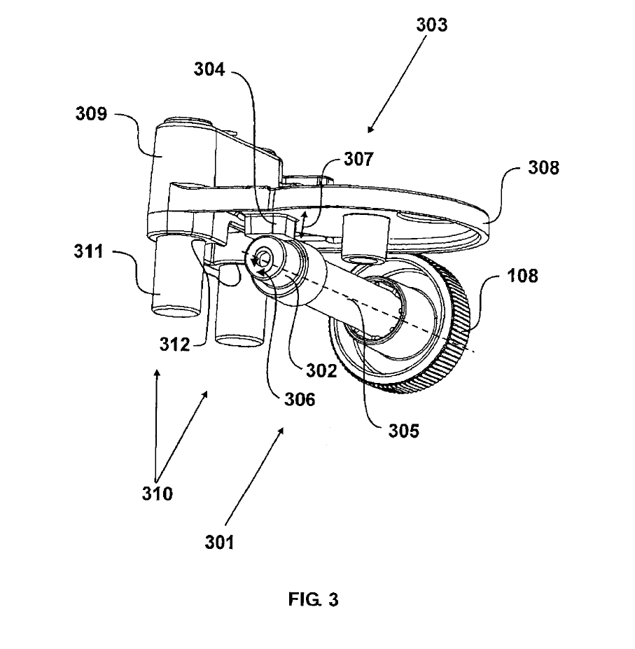

### FIG. 3

Features of the focusing mechanism of the microscope of FIG. 1 are shown in FIG. 3. The focusing mechanism comprises a cam and follower mechanism 301. The focal control provided by the cam and follower mechanism of the microscope is found to be sufficient for the microbiological uses of the microscope.

In an embodiment, the cam and follower mechanism 301 comprises a rotatable cam element 302 and a mounting element 303 comprising a follower 304 upon which the rotatable cam element 302 bears. In this example, the rotatable cam element 302 is manually operable by means of use of focusing knob 108; however it is to be appreciated that an alternative type of manually operable focusing device may be provided.

The cam element 302 is configured to rotate about an axis of rotation 305 in a direction as indicated by arrow 306, clock-wise or anti-clockwise; and this motion is translated to movement of the follower 304 in a direction as indicated by arrow 307, towards or away from the axis of rotation 305. In an example, the cam element comprises a rotatable body having a generally circular cross-section, which is mounted to rotate about an axis of rotation that is displaced from the centre of the generally circular cross-section. In an alternative arrangement, the cam element has an alternative cross-sectional shape. The cam element may be mounted to a rotatable body, for example such as an axle extending between the cam element and the focusing knob. The cam element may then extend radially outwardly of the axle.

In this embodiment, the focusing mechanism is configured such that the objective lens in the optical path is moveable relative to the substantially planar viewing stage by operation of the focusing mechanism. The mounting element 303 therefore supports an objective lens, which are together moveable closer to and further away from the substantially planar viewing stage and a subject sample held within the viewing port thereof. Mounting the objective lens element within the casing 102 enables a compact, portable, convenient design.

In this example, the mounting element 303 comprises a mounting frame 308 that is secured to a movable sleeve 309. The movable sleeve 309 is located around a pillar arrangement 310 that extends in direction that is substantially perpendicular to the general plane of the mounting frame 308. Therefore, with the mounting frame 308 oriented substantially horizontally relative to ground level, the pillar arrangement 310 is oriented substantially vertically relative to ground level and, in this general orientation, operation of the focusing mechanism causes the movable sleeve 309 to move upwards or downwards relative to ground level. In this example, the pillar arrangement comprises a pair of elongate pillars, such as pillar 311, which extend parallel one to the other. The internal profile of the two pillar receiving apertures of the sleeve, indicated at 312, and the external profile of the two pillars are relatively dimensioned to provide close tolerance fit between the sleeve 310 and the pair of pillars. A close tolerance fit between the movable sleeve 309 and the pillar arrangement 310 facilitates smooth movement of the sleeve 310 along the pillar arrangement 310.

The pillar arrangement 310 extends parallel to the objective lens disposed in the optical path of the microscope. Thus, by rotating the focusing knob 108, a user can selectively displace the objective lens element in the optical path at a desired available distance from the substantially planar viewing stage and a subject sample held within the viewing port thereof. Continuous turning of the focusing knob 108 in a single sense causes the objective lens in the optical path of the microscope to rise and fall in a smooth cycle. In an example, the cam mechanism 301 is configured such that maximum travel of the mounting element 303 is achieved within a half-revolution of the rotatable cam element 302. Thus, the position of best focus is encountered within a single evolution of the rotatable cam element.

An advantage of this feature of the cam and follower focusing mechanism is that a user may turn the focusing knob in any direction from the starting point and a focus position will be found without passing through the starting point. Thus, the cam and follower focusing mechanism provides for a user to find a position of best focus point simply, quickly and with accuracy.

The use of a cam and follower mechanism to provide the microscope focusing provides further significant advantages over a convention rack and pinion mechanism. Importantly, the cam and follower focusing mechanism can be made small enough to be utilized within a compact, portable microscope. However, the cam and follower focusing mechanism as described herein may be used in any type of microscope. Thus, the described cam and follower focusing mechanism may be used in a bench-top microscope or a portable microscope. In addition, the cam and follower focusing mechanism is mechanically simpler than a rack and pinion mechanism and is less expensive. Further, as described previously, the cam element can be configured to provide the position of best focus within a predetermined limit of travel. In an example, the relative dimensions and arrangement of the componentry of the microscope and the cam and follower focusing mechanism is such that contact between the objective lens aligned with the viewing port of the substantially planar viewing stage and a subject sample is prevented. Also, the cam and follower focusing mechanism does not require the use of any travel limiting end stops and hence there is no associated risk of mechanical impact damage to the cam and follower focusing mechanism or, in turn, the focal control of the microscope. It is to be understood that the cam and follower microscope focusing mechanism may have any suitable arrangement.

In an embodiment, the microscope comprises a biasing arrangement configured to maintain the mounting element 303 in contact with the rotatable cam element 302. In an example, the biasing arrangement is configured to urge the mounting element 303 in a substantially opposite direction to that in which the rotatable cam element 302 urges the mounting element 303. In an embodiment, the biasing arrangement comprises at least one spring. A biasing arrangement serves to ensure proper and reliable operation of the focusing cam mechanism and advantageously allows for the microscope to be used and focused when in any orientation.

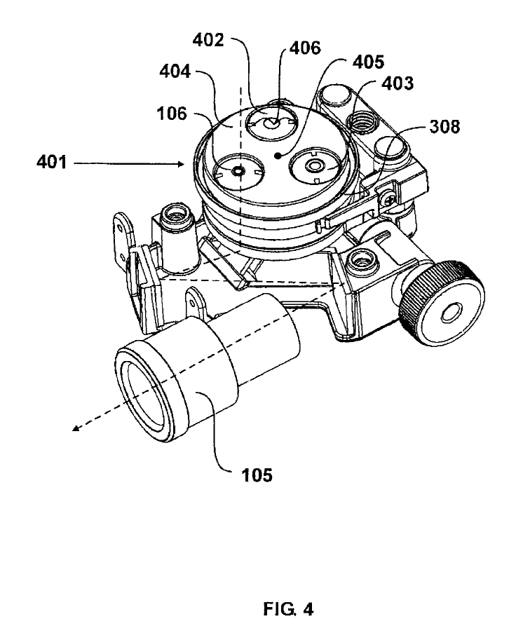

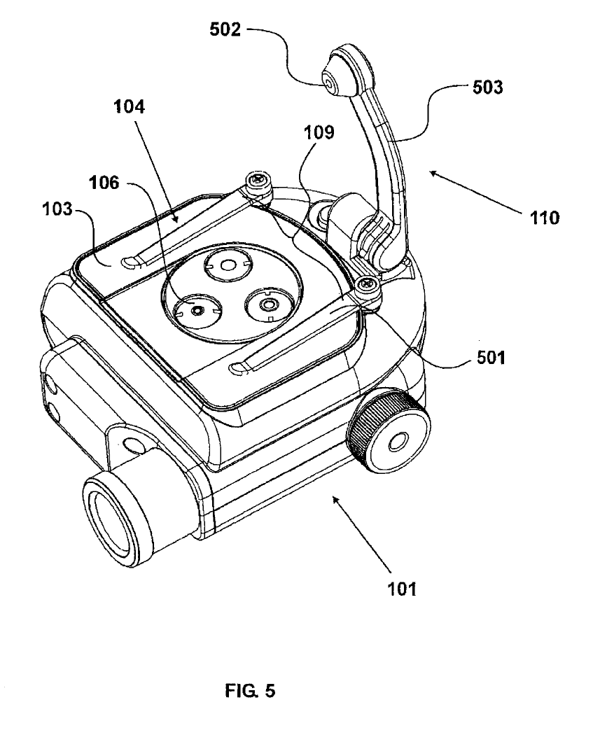

### FIG. 4

Features of the objective lens element of the microscope of FIG. 1 are shown in FIG. 4. As previously described, the microscope comprises an objective lens 106. In this embodiment, the objective lens element, indicated at 401, comprises a plurality of objective lenses that are each of a different magnification, and is configured such that each of the plurality of objective lenses is selectably disposable with the optical path of the microscope. Thus, in this example, the objective lens element 401 comprises a first objective lens 106, a second objective lens 402 and a third objective lens 403. However, alternative objective lens elements may comprise a lesser or greater number of objective lenses.

In this example, the 3 objective lenses 106, 402, 403 are mounted relative to a rotatably indexable member 404, which in turn is mounted relative to mounting frame 308. The objective lenses 106, 402, 403 are housed within the casing of the microscope, each with its optical axis perpendicular to the substantially planar viewing stage. The rotatably indexable member 404 is rotatable in a plane parallel to the substantially planar viewing stage, about an axis of rotation 405 perpendicular to the substantially planar viewing stage, to allow each of the 3 objective lenses 106, 402, 403 to be sequentially disposed within the optical path of the microscope. In this way, the user can select an objective lens to interpose within the optical path. Thereafter, the user can move that objective lens along its optical axis, by operation of the cam and follower focusing mechanism described with reference to FIG. 3, to focus the microscope on a sample.

Thus, the objective lens element is configured to be moved relative to the remainder of the microscope. By turning the optical path passing through the objective lens through 90° from the Z-axis direction into the XY-axes plane allows for a controllable objective lens arrangement; permitting convenient selection of an objective lens of a plurality of objective lenses and focusing of the selected objective lens.

In an embodiment, the microscope is configured to allow replacement of an objective lens. In an example, each objective lens is provided with a pair of diametrically-opposed notches, such as pair of notches 406, in an end accessible through the viewing port of the substantially planar viewing stage, to allow the objective lens to be engaged by a tool and removed. For example, a co-operable tool may be provided with prongs that locate within the notches and allow the objective lens to be released by a screw or lever action. Thus, the microscope may be configured to allow exchange of an objective lens of the objective lens element.

The lens of the eyepiece element 105 may be a conventional eyepiece lens, for example an RMS standard eyepiece, or may be provided by an eyepiece lens assembly made to satisfy the RMS standard. Alternatively or additionally, the eyepiece element may be provided with, or configured to receive, a lens of an electronic image capturing device, such as a digital camera. Thus, the microscope may be configured to allow exchange of an eyepiece lens of the eyepiece element. For this purpose, eyepiece element adapters may be provided, which may allow use of one or more lens types with the eyepiece element.

It is generally envisaged that objective lenses of ×5, ×10, ×40 and ×60 magnification could be used with a dry system, whilst ×80 and ×100 could be used with an oil immersion system if desired. Each objective lens may be a conventional objective lens, for example an RMS standard objective lens, or may be provided by an objective lens assembly made to satisfy the RMS standard. Preferably each objective lens is an achromatic lens.

To be useful in medical diagnosis, the microscope must provide a high net magnification. In an example, the objective lens element comprises objective lenses of ×10, ×40 and ×60 magnification. In an example, an eyepiece lens is provided that is of ×10 magnification. Thus, together, the different combinations of objective lenses and eyepiece lens of these magnifications provide net magnifications of ×100, ×400 and ×600. These magnifications may require very bright sample illumination in order to produce clearly visible images at the eyepiece element 105. In this embodiment, an illumination arrangement is therefore provided.

In an embodiment, the objective lenses are par focal and hence all share the same focal plane. This desirable feature operates such that when a focus is found on one of the objective lenses, the microscope remains in general focus when the other objective lenses are indexed into the light path; this saves a user from refocusing the microscope for each individual objective lens. This aspect of the microscope is also especially useful for examining objects at maximum power, allowing for a lower power to be initially selected for easy location of the object on the substantially planar viewing stage and centralization of the object within the viewing port, and then a higher power to subsequently indexed into position, thus ensuring that the object is both in the centre of view and in reasonable focus without requiring the user to perform any extra steps.

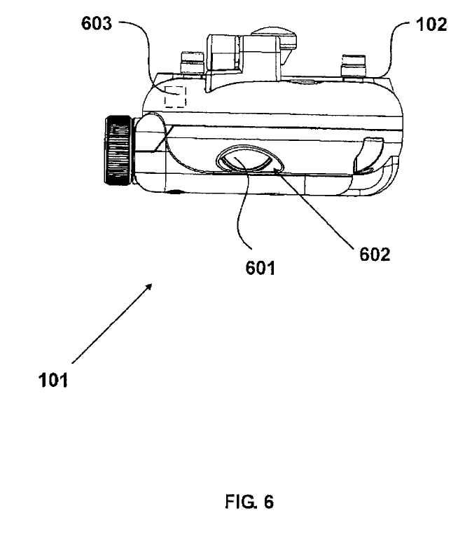

### FIG. 5

Further features of the microscope of FIG. 1 are shown in FIG. 5. In this example, the substantially planar viewing stage 103 is provided with a retaining arrangement, indicated at 109, for use in retaining an object thereon. As shown, the retaining mechanism may comprise one more clips, for retaining a conventional microscope slide or sample holder in a desired position against the substantially planar viewing stage and across the viewing port. In this illustrated example, a pair of spring clips, such as spring clip 501 is provided. The retaining mechanism may be adjustable to accommodate differently dimensioned microscope slides or sample holders. The retaining arrangement provides convenience for a user. In addition, this feature facilitates use of the microscope in an inverted orientation. For example, with oil immersion techniques, it would be desirable to use the microscope 101 with the substantially planar viewing stage 103 facing downwardly in order to keep the microscope 101 clean.

In an embodiment, the microscope comprises an illumination arrangement, indicated generally at 110, comprising a light emitting diode lamp 502 for illuminating a field of view of the objective lens 106 in the optical path. In an example, the light emitting diode lamp is a white-light emitting diode lamp (WLED). However, in alternative examples, a different type of light emitting diode lamp may be provided. The use of a light emitting diode lamp is useful for providing substantially even illumination across the target area. In an example, the relative dimensions of components and features of the microscope are such that the light emitting diode lamp will over-fill the aperture of the objective lens in the optical path. In an example, the relative dimensions of components and features of the microscope are such that a light emitting diode lamp of standard dimensions may be used.

In this embodiment, the light emitting diode lamp is located externally of the casing of the microscope. Also, the light emitting diode lamp 502 is supported by an illumination arm 503. In this example, the illumination arm 503 is adjustable, and is configured to be movable towards and away from the viewing port. The illumination arm 503 is movable from a first position in which the light emitting direction of the light emitting diode lamp 502 is substantially aligned with the optical axis of the objective lens in the optical path of the microscope. In the first position, the illumination arm 503 extends across the viewing port 104 of the substantially planar viewing stage 103. In this position, the illumination arm 503 obstructs access to the viewing port 104 of the substantially planar viewing stage 103. Therefore, the illumination arm 503 is movable from the first position into a second position in which the obstruction caused by the illumination arm 503 is substantially removed. This feature serves to facilitate access to the viewing port area by allowing the illumination arm to be moved. Thus, an illumination arm may be movable between a first position as illustrated in FIG. 1 and a second position as illustrated in FIG. 5.

As previously described, access to the viewing port area may be allowed to facilitate exchange of an objective lens. In an example, the movable illumination arm is configured to be locatable at each extreme position of movement and along of a plurality of predetermined increments of the available position range. Alternatively, or additionally, the movable illumination arm is configured to be positioned at any of an infinite number of positions along the available movement path. In an embodiment, the adjustable illumination arm has a single degree of freedom but in an alternative arrangement may have an additional degree of freedom.

In an alternative embodiment, the light emitting diode lamp is located at the distal end of a fixed-position cantilevered illumination arm, which extends across the viewing port so that is aligned with the optical axis of the objective lens in the optical path of the microscope. The fixed-position cantilevered illumination arm may then be shaped so as to allow access to an objective lens through the viewing port. In an example, the illumination arm is configured to support the light emitting diode at a distance of approximately 4 mm above the substantially planar viewing stage.

In an embodiment, the microscope comprises a power circuit arrangement configured to receive power from at least one power source and to supply power to the light emitting diode lamp. In an example, the microscope is configured to receive power by means of at least one of: a conventional dry cell battery arrangement, a USB connection and a solar power charger unit. For example, the microscope may be powered, or a battery charged, by a USB connection from a laptop computer. In an example, the light emitting diode lamp of the illumination arrangement is arranged to be powered by three AAA electrical cells, which may be held in a battery pack that in turn may be housed within the casing. The provision of a convenient power resource facilitates the use of the microscope in the field, in particular in areas with limited infrastructure.

The use of a light emitting diode lamp enables a sufficient level of illumination for the microscope to be provided with a device that is smaller and lighter than a conventional incandescent lamp. The use of the light emitting diode lamp also avoids the use of an elaborate, expensive and bulky conventional Abbé condenser that may be required to be used in combination with a conventional incandescent lamp. In addition, a light emitting diode lamp requires less power than an incandescent lamp able to provide equivalent illumination, which would need electrical mains power, or power from a twelve-volt car battery, typically not available or convenient to use in geographical areas in which the microscope 101 is intended for use.

The power supply is configured to be manually operable, such that the power supply to the light emitting diode lamp of the illumination arrangement may be turned on and turned off as desired by a user. In an embodiment an on/off switch, for example in the form of a button, is provided. In an embodiment, the power supply arrangement comprises a power timer facility, configured to turn off the power supply to the light emitting diode lamp of the illumination arrangement after a pre-determined duration of time has passed. In an example, the power timer facility is configured to switch off power after a period of 20 minutes. The length of a ‘power-on’ period may vary between applications, and the time-elapsed duration before shut-down may be adjustable. In an example, this function is user adjustable. The power timer facility serves to preserve power. It may also be useful in providing an operative with an indication as to power used and remaining power available from a particular source. In an example, a visual indicator is provided that operates to indicate when power is on. Power management is particularly advantageous in areas with limited infrastructure.

### FIG. 6

Yet further features of the microscope of FIG. 1 are shown in FIG. 6. In this embodiment, the microscope 101 comprises a brightness adjustment arrangement, which, in this example, is manually operable by means of rotation of a brightness adjustment wheel 601. It is to be appreciated that an alternative type of manually operable brightness adjustment device may be provided. The adjustable brightness feature enables the brightness of the light emitting diode lamp of the illumination arrangement to be adjusted to suit particular magnifications, or in response to the immediate surrounding light condition. For example, in an embodiment in which a white-light emitting diode (WLED) lamp is used, the default illumination provided may be suitable for one or more of a plurality of objective lenses of the microscope, but may require dimming for one or more of the other objective lenses. The brightness adjustment arrangement allows the light emitting diode lamp to be adjusted, within an available brightness range, whilst the field of view of the objective lens in the optical path remains fully illuminated. Brightness wheel adjustments for the light emitting diode lamp correspond to diaphragm adjustments for stepping down a conventional Abbé condenser used in combination with a conventional incandescent source.

In an example, the microscope 101 is provided with a drying agent, as indicated generally at 603. Thus, the microscope may be provided with one or portions of silica gel, such as may be provided in sachet form. In an example, the casing 102 of microscope 101 has one or more internal pockets for receiving the drying agent. It has been found that a microscope used in a tropical climate, with high humidity, is prone to problems arising from fungal growth on the lens, for example. The hermetic sealing of a microscope, for example by the provision labyrinth seals in casings and mountings and O-rings around lenses is expensive and unreliable. With silica gel, 1 g is rated as being able to keep 0.028316 m3 of air substantially dry. In an example, the casing 102 is provided with a volume of drying medium therein sufficient to maintain the internal volume of the casing substantially dehumidified when the atmosphere external of the casing has relatively humidity at or near 100%. Thus, with microscope 101, it is accepted that the external, humid atmosphere will penetrate the casing 102. However, the housing of silica gel for example, typically in the order of a few grams, held in corners and recesses of the casing 102 clear of the optical path, will dry out this air and maintain the interior of the microscope 101 sufficiently dry to avoid biological growth therein. It is envisaged that use of a drying agent in this way may prevent undesirable biological growth for substantially the entire design life of the microscope.

The microscope may be fabricated from any suitable material or combinations of materials. The microscope may be manufactured by any suitable method of manufacture comprising any suitable processes. In an example, the fabrication of the microscope comprises a combination of plastics materials and metals. In such an example, the microscope is robust so as to withstand general wear, to facilitate transportation and use.

1. A microscope comprising:
a casing comprising a substantially planar viewing stage having a viewing port extending therethrough,
an eyepiece element,
an objective lens element,
an optical path extending within said casing between said viewing port and said eyepiece element and folded by means of a plurality of reflectors, and
a focussing mechanism comprising a cam and follower mechanism and configured such that said objective lens element and said substantially planar viewing stage are relatively moveable by operation of said cam and follower mechanism.

2. The microscope of claim 1, wherein a first portion of said optical path between said viewing port and a first reflector of said plurality of reflectors extends in a first plane substantially perpendicularly to a second plane in which the remainder of said optical path extends.

3. The microscope of claim 2, wherein said second plane extends substantially parallely to said substantially planar viewing stage.

4. The microscope of claim 1, wherein said cam and follower mechanism comprises a manually operable rotatable cam element and a mounting frame follower element upon which said rotatable cam element bears.

5. The microscope of claim 4, wherein said cam and follower mechanism is configured such that maximum travel of said mounting frame follower element is achieved within a half-revolution of said rotatable cam element.

6. The microscope of claim 4, wherein said focussing mechanism is configured such that said objective lens element is moveable relative to said substantially planar viewing stage by operation of said cam and follower mechanism.

7. The microscope of claim 4, comprising a biasing arrangement configured to maintain said mounting frame follower element in contact with said rotatable cam element.

8. The microscope of claim 4, wherein said biasing arrangement is configured to urge said mounting frame follower element in a substantially opposite direction to that in which said rotatable cam element urges said mounting frame follower element.

9. The microscope of claim 1, wherein said objective lens element comprises a plurality of objective lenses, each of a different magnification, and configured such that each of said plurality of objective lenses is selectably disposable within said optical path.

10. The microscope of claim 9, wherein said plurality of objective lenses are mounted relative to a rotatably indexable member.

11. The microscope of claim 1, wherein said objective lens element comprises at least one objective lens of: ×5, ×10, ×40, ×60, ×80 and ×100 magnification.

12. The microscope of claim 1, wherein said plurality of reflectors comprises a plurality of mirrors.

13. The microscope of claim 2, wherein said first reflector is manufactured to an accuracy that is higher than the accuracy of each remaining reflector of said plurality of reflectors.

14. The microscope of claim 1, wherein said eyepiece element comprises an eyepiece lens of: ×10 magnification.

15. The microscope of claim 1, configured to allow exchange of a lens of at least one of said eyepiece element, said objective lens element.

16. The microscope of claim 1, further comprising an illumination arrangement comprising a light emitting diode lamp.

17. The microscope of claim 16, wherein said illumination arrangement comprises brightness adjusting means for adjusting the brightness of said light emitting diode lamp.

18. The microscope of claim 16, wherein said light emitting diode lamp is mounted to an adjustable illumination arm.

19. The microscope of claim 16, comprising a power circuit arrangement configured to receive power by means of at least one of: a conventional dry cell battery arrangement, a USB connection, a solar power charger unit.

20. The microscope of claim 1, wherein said casing defines at least one pocket for receiving a drying medium.
